(19) United States
(12) Patent Application Publication
(10) Pub. No.: US 2024/0101471 A1
(43) Pub. Date: Mar. 28, 2024

(54) STRENGTHENED GLASS SHEET AND MANUFACTURING METHOD THEREFOR

(71) Applicant: Nippon Electric Glass Co., Ltd., Shiga (JP)

(72) Inventor: Ken YUKI, Shiga (JP)

(21) Appl. No.: 18/273,657

(22) PCT Filed: Feb. 1, 2022
(86) PCT No.: PCT/JP2022/003882

§ 371 Date: Jul. 21, 2023

(30) Foreign Application Priority Data
Feb. 10, 2021 (JP) 2021-019754

(51) Int. Cl. C03C 21/00; C03C 3/085; C03C 3/093; C03C 3/097

(52) U.S. Cl. CPC C03C 21/002; C03C 3/085; C03C 3/093; C03C 3/097

(57) ABSTRACT

Provided is a tempered glass sheet that has a softening point lower than that of conventional lithium aluminosilicate glass, exhibits excellent thermal bending moldability, and is not easily broken when dropped. Also provided is a method for manufacturing the tempered glass sheet. The tempered glass sheet of the present invention is characterized in that the tempered glass sheet includes, as a glass composition in terms of mol %, from 45 to 70% of SiO₂, from 9 to 25% of Al₂O₃, from 0 to 10% of B₂O₃, from 4 to 15% of Li₂O, from 1 to 21% of Na₂O, from 0 to 10% of K₂O, from 0.03 to 10% of MgO, from 0 to 10% of ZnO, from 0 to 15% of P₂O₅, and from 0.001 to 0.30% of SnO₂, and the tempered glass sheet satisfies [Li₂O]+[Na₂O]+[K₂O]≥15%, and ([Li₂O]+[Na₂O]+[K₂O]+[ZnO])/[Al₂O₃]≥1.1.

### TECHNICAL FIELD

The present invention relates to a tempered glass sheet and a method for manufacturing the same, and particularly relates to a tempered glass sheet suitable as a cover glass for a touch panel display of a device such as a mobile phone, a digital camera, or a personal digital assistant (PDA), and to a method for manufacturing the tempered glass sheet.

### BACKGROUND ART

An ion-exchange treated tempered glass sheet is used as a cover glass for a touch panel display in applications such as a mobile phone, a digital camera, or a personal digital assistant (PDA) (see Patent Document 1 and Non-Patent Document 1).

### CITATION LIST

### Patent Literature

Patent Document 1: JP 2006-083045 A
Patent Document 2: JP 2016-524581 T
Patent Document 3: JP 2011-510903 T

### Non-Patent Document

Non-Patent Document 1: IZUMITANI, Tetsuro et al., “Atarashii Garasu to Sono Bussei (New Glass and Its Physical Properties)”, First Edition, Management System Laboratory. Co., Ltd., Aug. 20, 1984, pp. 451-498

### SUMMARY OF INVENTION

### Technical Problem

When a smartphone is accidentally dropped on the pavement or the like, the cover glass may be damaged, and the smartphone may become dysfunctional. In order to avoid such a situation, it is important to increase the strength of a tempered glass sheet.

Increasing Depth of Layer is an effective method for increasing the strength of the tempered glass sheet. Specifically, if the cover glass collides with the pavement when a smartphone is dropped, protrusions or sand grains on the pavement penetrate into the cover glass and reach a tensile stress layer, leading to the damage of the cover glass. In view of the foregoing, when a Depth of Layer of compressive stress layer is increased, protrusions or sand grains on the pavement are less likely to reach the tensile stress layer, and thus the probability of cover glass damage can be reduced.

In recent years, a trend has developed for smartphones equipped with 3D curved displays, and the demand for 3D curved cover glass is increasing. Such 3D curved cover glass is often produced by thermal bending and molding using a carbon mold. Furthermore, the lower the softening point of the glass, the easier it is thermally bend and mold the glass, and thus a higher production efficiency can be achieved.

Lithium aluminosilicate glass is advantageous in achieving a large Depth of Layer. In particular, when a glass sheet to be tempered formed of lithium aluminosilicate glass is immersed in a molten salt containing NaNO₃, Li ions in the glass exchange with Na ions in the molten salt, resulting in a tempered glass sheet having a large Depth of Layer. Furthermore, lithium aluminosilicate glass contains a large amount of Li₂O in the glass composition, thereby having a feature of lithium aluminosilicate glass in that the softening point can be lowered.

However, with conventional lithium aluminosilicate glass, when the glass composition is designed such that the softening point is reduced, the compressive stress value of the compressive stress layer may be too small, and the strength of the tempered glass sheet may decrease.

The present invention was developed in view of the above circumstances, and a technical issue to be addressed by the present invention is to provide a tempered glass sheet that has a softening point lower than that of conventional lithium aluminosilicate glass, exhibits excellent thermal bending and moldability, and is not easily broken when dropped, and to provide a method for manufacturing such a tempered glass sheet.

### Solution to Problem

As a result of various investigations, the present inventor, etc. found that the above technical issue can be solved by limiting the glass composition to a predetermined range, and proposed the finding as the present invention. That is, a tempered glass sheet of the present invention is characterized in that the tempered glass sheet includes, as a glass composition in terms of mol %, from 45 to 70% of SiO₂, from 9 to 25% of Al₂O₃, from 0 to 10% of B₂O₃, from 4 to 15% of Li₂O, from 1 to 21% of Na₂O, from 0 to 10% of K₂O, from 0.03 to 10% of MgO, from 0 to 10% of ZnO, from 0 to 15% of P₂O₅, and from 0.001 to 0.30% of SnO₂, and the tempered glass sheet satisfies [Li₂O]+[Na₂O]+[K₂O]≥15%, and ([Li₂O]+[Na₂O]+[K₂O]+[ZnO])/[Al₂O₃]≥1.1. Here, “[Li₂O]” refers to a content of Li₂O in mol %. “[Na₂O]” refers to a content of Na₂O in mol %. “[K₂O]” refers to a content of K₂O in mol %. “[ZnO]” refers to a content of ZnO in mol %. “[Al₂O₃]” refers to a content of Al₂O₃ in mol %. Here, the “[Li₂O]+[Na₂O]+[K₂O]” refers to the total content of Li₂O, Na₂O, and K₂O. “([Li₂O]+[Na₂O]+[K₂O]+[ZnO])/[Al₂O₃]” refers to a value obtained by dividing the total content of Li₂O, Na₂O, K₂O and ZnO by the content of Al₂O₃.

Also, a content of ZnO in the tempered glass sheet of the present invention is preferably 1.5 mol % or greater.

In addition, a content of Cl in the tempered glass sheet of the present invention is preferably 0.02 mol % or greater.

The tempered glass sheet of the present invention is characterized by having a softening point of 900° C. or lower. As used herein, “softening point” refers to a value measured on the basis of the method of ASTM C338.

In the tempered glass sheet of the present invention, preferably a compressive stress value at an outermost surface of the compressive stress layer is from 200 to 1200 MPa, and the compressive stress value at a depth of 30 μm is from 70 to 500 MPa.

In the tempered glass sheet of the present invention, a Depth of Layer of the compressive stress layer is preferably from 50 to 200 μm. Here, the expressions “compressive stress value at the outermost surface” and “Depth of Layer” each refer to a value measured based on a retardation distribution curve observed using, for example, a scattered light photoelastic stress meter SLP-1000 (available from Orihara Industrial Co., Ltd.). Moreover, the expression “Depth of Layer” refers to a depth at which a stress value becomes zero. Note that, the stress characteristics were calculated using a refractive index of 1.51 and an optical elasticity constant of 29.0 [(nm/cm)/MPa] for each sample to be measured.

In addition, the temperature at a high-temperature viscosity of 10^{2.5} dPa·s of the tempered glass sheet of the present invention is preferably 1600° C. or lower. Here, the “temperature at a high-temperature viscosity of 10^{2.5} dPa·s” can be measured by, for example, the platinum ball pull-up method.

The tempered glass sheet according to the present invention preferably has an overflow-confluent surface at the central portion in the sheet thickness direction, that is, the tempered glass sheet is preferably formed by an overflow down-draw method. Here, “overflow downdraw method” is a method of manufacturing a glass sheet, in which molten glass overflows from both sides of a refractory forming body, and the overflowed molten glass joins at the lower end of the refractory forming body while being drawn downward, forming a glass sheet. In the glass formed by the overflow down-draw method, a mating surface (=confluent surface) generated by the confluence of the molten glass is likely to appear at the central portion in the sheet thickness direction of the glass cross-section.

The tempered glass sheet according to an embodiment of the present invention is preferably for use as a cover glass for a touch panel display.

In the tempered glass sheet of the present invention, a content of Fe₂O₃ is preferably from 0.001 to 0.1 mol %.

Moreover, a content of TiO₂ in the tempered glass sheet of the present invention is preferably from 0.001 to 0.1 mol %.

The tempered glass sheet according to an embodiment of the present invention preferably has a stress profile in a thickness direction including at least a first peak, a second peak, a first bottom, and a second bottom. In the present invention, the first peak, the second peak, the first bottom, and the second bottom are defined as follows. FIG. 1 is a schematic view of a stress profile obtained by measuring stress in a depth direction from the surface of the tempered glass sheet with the compressive stress as a positive number and the tensile stress as a negative number, and FIG. 2 is an enlarged view of a low compressive stress region in the stress profile illustrated in FIG. 1. Here, the point “a” at which the compressive stress becomes a maximum value at the surface is defined as the first peak, the point “b” at which the compressive stress gradually decreases in the depth direction from the first peak and becomes a minimum value is defined as the first bottom, the point “c” at which the compressive stress gradually increases from the first bottom in the depth direction to become a maximum value is defined as the second peak, and the point “d” at which the tensile stress gradually decreases from the second peak in the depth direction to become a minimum value is defined as the second bottom.

The stress profile in the thickness direction of the tempered glass sheet of the present invention preferably has an inflection point.

In addition, a method for manufacturing the tempered glass sheet of the present invention includes: a preparation step of preparing a glass sheet for tempering including, as a glass composition in terms of mol %, from 45 to 70% of SiO₂, from 9 to 25% of Al₂O₃, from 0 to 10% of B₂O₃, from 4 to 15% of Li₂O, from 1 to 21% of Na₂O, from 0 to 10% of K₂O, from 0.03 to 10% of MgO, from 0 to 10% of ZnO, from 0 to 15% of P₂O₅, and from 0.001 to 0.30% of SnO₂, and the glass sheet for tempering satisfying [Li₂O]+[Na₂O]+[K₂O]≥15%, and ([Li₂O]+[Na₂O]+[K₂O]+[ZnO])/[Al₂O₃]≥1.1; and an ion exchange step of performing an ion exchange treatment for the glass sheet for tempering to obtain a tempered glass sheet having a compressive stress layer on a surface.

In addition, the method for manufacturing a tempered glass sheet of the present invention preferably uses a mixed molten salt of KNO₃ and NaNO₃ for the ion exchange treatment.

Moreover, in the method of manufacturing a tempered glass sheet of the present invention, the ion exchange treatment is preferably performed once.

The glass sheet for tempering of the present invention includes, as a glass composition in terms of mol %, in an ion-exchangeable glass sheet for tempering, from 45 to 70% of SiO₂, from 9 to 25% of Al₂O₃, from 0 to 10% of B₂O₃, from 4 to 15% of Li₂O, from 1 to 21% of Na₂O, from 0 to 10% of K₂O, from 0.03 to 10% of MgO, from 0 to 10% of ZnO, from 0 to 15% of P₂O₅, and from 0.001 to 0.30% of SnO₂, and the glass sheet for tempering satisfying [Li₂O]+[Na₂O]+[K₂O]≥15%, and ([Li₂O]+[Na₂O]+[K₂O]+[ZnO])/[Al₂O₃]≥1.1.

### BRIEF DESCRIPTION OF DRAWINGS

FIG. 1 is an explanatory diagram illustrating a stress profile having a first peak a, a first bottom b, a second peak c, and a second bottom d.

FIG. 2 is an enlarged explanatory diagram of a low compressive stress region in the stress profile illustrated in FIG. 1.

FIG. 3 is an explanatory diagram illustrating a stress profile having an inflection point.

FIG. 4 is a stress profile of Sample Nos. 0001 to 0004 presented in the Examples section.

### DESCRIPTION OF EMBODIMENTS

Preferably, the tempered glass sheet (glass sheet for tempering) of the present invention contains, as a glass composition in terms of mol %, from 45 to 70% of SiO₂, from 9 to 25% of Al₂O₃, from 0 to 10% of B₂O₃, from 4 to 15% of Li₂O, from 1 to 21% of Na₂O, from 0 to 10% of K₂O, from 0.03 to 10% of MgO, from 0 to 10% of ZnO, from 0 to 15% of P₂O₅, and from 0.001 to 0.30% of SnO₂, and satisfies [Li₂O]+[Na₂O]+[K₂O]≥15%, and ([Li₂O]+[Na₂O]+[K₂O]+[ZnO])/[Al₂O₃]≥1.1. The reason for limiting the content range of each component will be described below. In the descriptions of the content range of each component, “%” refers to “mol %” unless otherwise specified.

SiO₂ is a component that forms the network of the glass. When the content of SiO₂ is too small, vitrification is difficult, and a thermal expansion coefficient is too high, and thus the thermal shock resistance is likely to decrease. Thus, a lower limit range of the content of SiO₂ is preferably 45% or greater, 50% or greater, 55% or greater, 57% or greater, 58% or greater, 58.5% or greater, 59% or greater, or 60% or greater, and is particularly preferably 61% or greater. On the other hand, too high a content of SiO₂ may likely reduce the meltability and formability, and in addition, excessively reduce the thermal expansion coefficient and thus make it difficult to match the thermal expansion coefficient of the peripheral material. Thus, the upper limit range of SiO₂ is preferably 70% or less, 69.5% or less, 69% or less, 68.5% or less, 68% or less, 67.5% or less, 67% or less, 66.5% or less, 66% or less, 65.5% or less, 65% or less, 64.5% or less, 64% or less, 63.5% or less, 63% or less, or 62.5% or less, and is particularly preferably 62% or less.

Al₂O₃ is a component that enhances ion exchange performance, and is also a component that increases a strain point, Young's modulus, fracture toughness, and Vickers hardness. Therefore, the lower limit range of Al₂O₃ is preferably 9% or greater, 9.2% or greater, 9.4% or greater, 9.5% or greater, 9.8% or greater, 10.0% or greater, 10.3% or greater, 10.5% or greater, 10.8% or greater, 11% or greater, 11.2% or greater, 11.4% or greater, 11.6% or greater, 11.8% or greater, 12% or greater, 12.5% or greater, 13% or greater, 13.5% or greater, 14% or greater, 14.4% or greater, 15% or greater, 15.3% or greater, 15.6% or greater, 16% or greater, 16.5% or greater, 17% or greater, 17.2% or greater, 17.5% or greater, 17.8% or greater, 18% or greater, greater than 18%, or 18.3% or greater, and is particularly preferably 18.5% or greater, 18.6% or greater, 18.7% or greater, or 18.8% or greater. On the other hand, when the content of Al₂O₃ is too large, a viscosity in high temperature increases, and thus the meltability and formability are likely to decrease. In addition, devitrified crystals are likely to precipitate in the glass, making it difficult to form the glass into a sheet shape using the overflow downdraw method or the like. In particular, when an alumina-based refractory is used as a refractory forming body to form the glass into a sheet shape using the overflow downdraw method, devitrified crystals of spinel are likely to precipitate at the interface with the alumina-based refractory. Furthermore, oxidation resistance also decreases, and thus it is difficult to be applied to an acid treatment process. Thus, the upper limit range of Al₂O₃ is preferably 25% or less, 21% or less, 20.5% or less, 20% or less, 19.9% or less, 19.5% or less, of 19.0% or less, and is particularly preferably 18.9% or less. When the content of Al₂O₃, which has a large influence on ion exchange performance, is in the preferred range, a profile having a first peak, a second peak, a first bottom, and a second bottom forms easily.

B₂O₃ is a component that lowers viscosity in high temperature or density, stabilizes the glass to make it difficult for crystals to precipitate, and lowers liquidus temperature. B₂O₃ is also a component that increases the binding force of oxygen electrons by cations and lowers the basicity of the glass. When the content of B₂O₃ is too small, the Depth of Layer in the ion exchange between Li ions contained in the glass and Na ions in a molten salt becomes too deep, and as a result, the compressive stress value (CS_{Na}) of the compressive stress layer is easily reduced. In addition, the glass may become unstable, and devitrification resistance may decrease. In addition, the basicity of the glass may become too high, the amount of O₂ released by the reaction of a fining agent may become small, a bubble formation property may decrease, and bubbles may remain in the glass when the glass is formed into a sheet shape. Therefore, the lower limit range of B₂O₃ is preferably 0% or greater, 0.10% or greater, 0.12% or greater, 0.15% or greater, 0.18% or greater, 0.20% or greater, 0.23% or greater, 0.25% or greater, 0.27% or greater, 0.30% or greater, 0.35% or greater, 0.38% or greater, 0.4% or greater, 0.42% or greater, 0.45% or greater, 0.5% or greater, 0.6% or greater, 0.7% or greater, 0.8% or greater, or 0.9% or greater, and is particularly preferably 1% or greater. Meanwhile, when the content of B₂O₃ is too large, the Depth of Layer may become small. In particular, the efficiency of ion exchange between the Na ions contained in the glass and the K ions in a molten salt is likely to decrease, and the Depth of Layer (DOL_ZERO_{K}) of the compressive stress layer is likely to decrease. Thus, the upper limit range of B₂O₃ is preferably 10% or less, 9.5% or less, 9% or less, 8.5% or less, 8% or less, 7.5% or less, 7% or less, 6% or less, 5.5% or less, 5% or less, 4% or less, 3.8% or less, 3.5% or less, 3.3% or less 3.2% or less, 3.1% or less, 3% or less, 2.9% or less, 2.8% or less, or 2.5% or less, and is particularly preferably 2.0% or less. When the content of B₂O₃ is in the preferred range, a profile having a first peak, a second peak, a first bottom, and a second bottom forms easily.

Li₂O is an ion exchange component, and in particular, an essential component for exchanging the Li ions contained in the glass with the Na ions in a molten salt to achieve a large Depth of Layer. Li₂O is also a component that lowers viscosity in high temperature to increase meltability or formability and a component that increases the Young's modulus. Therefore, the lower limit range of Li₂O is preferably 4% or greater, 4.2% or greater, 4.3% or greater, 4.4% or greater, 4.5% or greater, 4.7% or greater, 4.9% or greater, 5% or greater, 5.2% or greater, 5.5% or greater, 6.5% or greater, 7% or greater, 7.3% or greater, 7.5% or greater, or 7.8% or greater, and is particularly preferably 8% or greater. Thus, the upper limit of Li₂O is preferably 15% or less, 13% or less, 12% or less, 11.5% or less, 11% or less, 10.5% or less, or less than 10%, and is particularly preferably 9.9% or less, 9% or less, or 8.9% or less.

Na₂O is an ion-exchange component and is also a component that reduces the high-temperature viscosity to increase the meltability and formability. Na₂O is also a component that improves devitrification resistance, and in particular, a component that suppresses devitrification caused by reaction with an alumina-based refractory. Thus, the lower limit range of Na₂O is preferably 1% or greater, 2% or greater, 3% or greater, 4% or greater, 5% or greater, 6% or greater, 7% or greater, 7.5% or greater, 8% or greater, 8.5% or greater, or 8.8% or greater, and is particularly preferably 9% or greater. Meanwhile, when the content of Na₂O is too large, thermal expansion coefficient is too high, and thus thermal shock resistance is likely to decrease. In addition, the component balance of the glass composition is lacked, and thus the devitrification resistance may be reduced. Thus, the upper limit range of Na₂O is preferably 21% or less, 20% or less, or 19% or less, and is particularly preferably 18% or less, 15% or less, 13% or less, or 11% or less, and is even more particularly preferably 10% or less.

K₂O is a component that reduces the high-temperature viscosity to increase the meltability and formability, However, when the content of K₂O is too large, thermal expansion coefficient is too high, and thermal shock resistance is likely to decrease. The compressive stress value at the outermost surface is also likely to decrease. Thus, the upper limit range of K₂O is preferably 10% or less, 7% or less, 6% or less, 5% or less, 4% or less, 3% or less, or 2% or less, 1.5% or less, 1% or less, less than 1%, or 0.5% or less, and is particularly preferably less than 0.1%. Note that, when attention is given to the viewpoint of increasing the Depth of Layer, the lower limit range of K₂O is preferably 0% or greater, 0.01% or greater, 0.02% or greater, 0.03% or greater, 0.05% or greater, 0.08% or greater, 0.1% or greater, or 0.3% or greater, and is particularly preferably 0.5% or greater.

MgO is a component that lowers viscosity in high temperature to increase meltability or formability and that raises strain point or the Vickers hardness. MgO is also a component that, among alkaline earth metal oxides, has a large effect on improving ion exchange performance. However, when the content of MgO is too large, devitrification resistance is likely to decrease, and in particular, devitrification caused by the reaction with an alumina-based refractory becomes difficult to suppress. As such, the content of MgO is preferably from 0.03 to 10%, from 0.05 to 7%, from 0.1 to 5%, from 0.1 to 6%, from 0.2 to 5.5%, from 0.5 to 5%, or from 0.7 to 4.5%, and is particularly preferably from 1.0 to 4.0%.

ZnO is a component that improves ion exchange performance and, in particular, a component that has a large effect on increasing the compressive stress value on the outermost surface. In addition, ZnO is also a component that reduces the high-temperature viscosity without significantly reducing the low-temperature viscosity. The lower limit range of ZnO is preferably 0% or greater, 0.1% or greater, 0.3% or greater, 0.5% or greater, 0.7% or greater, 1% or greater, 1.1% or greater, 1.5% or greater, 1.8% or greater, 2.0% or greater, 2.5% or greater, 3.0% or greater, 3.1% or greater, or 3.2% or greater, and is particularly preferably 3.5% or greater. Meanwhile, when the content of ZnO is too large, the glass tends to phase-separate, devitrification resistance tends to decrease, density tends to increase, or the Depth of Layer tends to become small. Thus, the upper limit range of ZnO is preferably 10% or less, 8% or less, 7% or less, 6% or less, 5.5% or less, 5.2% or less, 5% or less, or 4.5% or less, and is particularly preferably 4% or less.

P₂O₅ is a component that improves ion exchange performance, and, in particular, a component that increases the Depth of Layer. P₂O₅ is also a component that improves acid resistance. P₂O₅ is also a component that increases the binding force of oxygen electrons by cations and lowers the basicity of the glass. When the content of the P₂O₅ is too small, ion exchange performance may not be sufficiently exhibited. In particular, the efficiency of ion exchange between the Na ions contained in the glass and the K ions in a molten salt is likely to decrease, and the Depth of Layer (DOL_ZERO_{K}) of the compressive stress layer is likely to decrease. In addition, the glass may become unstable, and devitrification resistance may decrease. In addition, the basicity of the glass may become too high, the amount of O₂ released by the reaction of a fining agent may become small, a bubble formation property may decrease, and bubbles may remain in the glass when the glass is formed into a sheet shape. Therefore, the lower limit range of P₂O₅ is preferably 0% or greater, 0.01% or greater, 0.02% or greater, 0.03% or greater, 0.05% or greater, 0.1% or greater, 0.4% or greater, 0.7% or greater, 1% or greater, 1.2% or greater, 1.4% or greater, 1.6% or greater, 2% or greater, 2.3% or greater, 2.5% or greater, 2.6% or greater, 2.7% or greater, 2.8% or greater, 2.9% or greater, 3.0% or greater, 3.2% or greater, 3.5% or greater, 3.8% or greater, 3.9% or greater, 4.0% or greater, 4.1% or greater, 4.2% or greater, 4.3% or greater, 4.4% or greater, or 4.5% or greater, and is particularly preferably 4.6% or greater. Meanwhile, when the content of P₂O₅ is too large, the glass is likely to phase-separate, or water resistance is likely to decrease. In addition, the Depth of Layer in the ion exchange between the Li ions contained in the glass and the Na ions in a molten salt becomes too large, and as a result, the compressive stress value (CS_{Na}) of the compressive stress layer is likely to become small. Thus, the upper limit range of P₂O₅ is preferably 15% or less, 10% or less, 8% or less, 7% or less, 6% or less, 5% or less, 4.9% or less, or 4.8% or less. When the content of the P₂O₅ is within the preferred range, a non-monotonic profile is easily formed.

SnO₂ is a fining agent and a component that improves ion exchange performance.

However, when the content of SnO₂ is too large, devitrification resistance is likely to decrease. Therefore, the lower limit range of SnO₂ is preferably 0.001% or greater, 0.002% or greater, 0.005% or greater, or 0.007% or greater, and is particularly preferably 0.010% or greater, and the upper limit range is preferably 0.30% or less, 0.27% or less, 0.25% or less, 0.20% or less, 0.18% or less, 0.15% or less, 0.12% or less, 0.10% or less, 0.09% or less, 0.08% or less, 0.07% or less, 0.06% or less, 0.05% or less, 0.047% or less, 0.045% or less, 0.042% or less, 0.040% or less, 0.038% or less, 0.035% or less, 0.032% or less, 0.030% or less, 0.025% or less, or 0.020% or less, and is particularly preferably 0.015% or less.

The content of [Li₂O]+[Na₂O]+[K₂O] is preferably 15% or greater, 15.2% or greater, 15.4% or greater, 15.5% or greater, 15.8% or greater, 16% or greater, 16.5% or greater, 17% or greater, 17.5% or greater, 18% or greater, 18.5% or greater, 19% or greater, 19.5% or greater, 20% or greater, 20.5% or greater, or 21% or greater, and is particularly preferably 22% or greater. When the content of [Li₂O]+[Na₂O]+[K₂O] is too small, the efficiency of ion exchange is likely to decrease, and a low softening point is not easily obtained. On the other hand, when the content of [Li₂O]+[Na₂O]+[K₂O] is too large, chemical resistance tends to decrease. The content of [Li₂O]+[Na₂O]+[K₂O] is preferably from 30% or less, 28% or less, 25% or less, or 24% or less, and is particularly preferably 23% or less.

The molar ratio of ([Li₂O]+[Na₂O]+[K₂O]+[ZnO])/[Al₂O₃] is preferably 1.1 or higher, 1.2 or higher, 1.3 or higher, or 1.4 or higher, and is particularly preferably 1.5 or higher. When the molar ratio of ([ZnO]+[Li₂O]+[Na₂O]+[K₂O])/[Al₂O₃] is too small, the efficiency of ion exchange is likely to decrease, and a low softening point is not easily obtained. On the other hand, when the molar ratio of ([ZnO]+[Li₂O]+[Na₂O]+[K₂O]+[Al₂O₃] is too large, the efficiency of ion exchange is likely to decrease. Thus, the molar ratio of ([ZnO]+[Li₂O]+[Na₂O]+[K₂O])/[Al₂O₃] is preferably 2.5 or less, 2.4 or less, 2.3 or less, 2.2 or less, 2.1 or less, 2 or less, or 1.8 or less, and is particularly preferably 1.6 or less.

The molar ratio of ([Li₂O]+[Na₂O]+[K₂O])/[Al₂O₃] is preferably from 0.7 to 2.0, from 0.75 to 1.2, from 0.8 to 1.5, or from 0.83 to 1.2, is preferably 0.84 or higher, 0.85 or higher, 0.86 or higher, 0.87 or higher, 0.88 or higher, 0.9 or higher, 0.95 or higher, 0.98 or higher, 1.0 or higher, 1.1 or higher, or 1.2 or higher, and is particularly preferably 1.3 or higher. When the molar ratio of ([Li₂O]+[Na₂O]+[K₂O])/[Al₂O₃] is too small, the efficiency of ion exchange is likely to decrease. Meanwhile, when the molar ratio of ([Li₂O]+[Na₂O]+[K₂O])/[Al₂O₃] is too large, the efficiency of ion exchange is also likely to decrease. The molar ratio of ([Li₂O]+[Na₂O]+[K₂O])/[Al₂O₃] is preferably 2.0 or less, 1.8 or less, 1.7 or less, 1.6 or less, 1.5 or less, 1.4 or less, 1.3 or less, 1.2 or less, 1.1 or less, or 1.0 or less, and is particularly preferably 0.95 or less. Note that “([Li₂O]+[Na₂O]+[K₂O])/[Al₂O₃]” refers to a value obtained by dividing the total content of Li₂O, Na₂O, and K₂O by the content of Al₂O₃.

The molar ratio of [MgO]/[Al₂O₃] is preferably 0.40 or less, 0.35 or less, 0.30 or less, 0.25 or less, 0.20 or less, 0.19 or less, 0.18 or less, 0.17 or less, 0.16 or less, 0.15 or less, or 0.12 or less, and is particularly preferably 0.10 or less. When the molar ratio thereof is too large, a reaction product is likely to be formed when contact is made with a molded body (particularly an alumina molded body) at a high temperature, and the quality of the glass formed into a sheet shape may be reduced. Meanwhile, the lower limit of the molar ratio of [MgO]/[Al₂O₃] is not particularly limited, but is substantially 0.01 or higher, 0.02 or higher, 0.03 or higher, or 0.04 or higher, and in particular, is 0.05 or higher. Note that “[MgO]/[Al₂O₃]” indicates a value obtained by dividing the content of MgO by the content of Al₂O₃.

When the molar ratio of ([SiO₂]+[B₂O₃]+[P₂O₅])/((100×[SnO₂])×([Li₂O]+[Na₂O]+[K₂O]+[MgO]+[CaO]+[BaO]+[SrO]+[ZnO]+[Al₂O₃])) is regulated, devitrification resistance can be increased while also increasing clarity. The molar ratio of ([SiO₂]+[B₂O₃]+[P₂O₅])/((100×[SnO₂])×([Li₂O]+[Na₂O]+[K₂O]+[MgO]+[CaO]+[BaO]+[SrO]+[ZnO]+[Al₂O₃])) is preferably 0.15 or higher, 0.20 or higher, 0.22 or higher, 0.25 or higher, 0.26 or higher, 0.27 or higher, 0.30 or higher, 0.33 or higher, 0.35 or higher, 0.37 or higher, 0.38 or higher, 0.39 or higher, 0.40 or higher, 0.41 or higher, 0.42 or higher, 0.43 or higher, 0.44 or higher, 0.45 or higher, 0.48 or higher, 0.50 or higher, 0.51 or higher, 0.52 or higher, 0.53 or higher, or 0.54 or higher, and is particularly preferably 0.55 or higher. When the molar ratio of ([SiO₂]+[B₂O₃]+[P₂O₅])/((100×[SnO₂])×([Li₂O]+[Na₂O]+[K₂O]+[MgO]+[CaO]+[BaO]+[SrO]+[ZnO]+[Al₂O₃])) is too small, SnO₂ product is likely to precipitate. In addition, the amount of oxygen released from a fining agent during melting and molding is likely to decrease, and bubbles are likely to remain in the glass when the glass is formed into a sheet shape. The upper limit of the molar ratio of ([SiO₂]+[B₂O₃]+[P₂O₅])/((100×[SnO₂])×([Li₂O]+[Na₂O]+[K₂O]+[MgO]+[CaO]+[BaO]+[SrO]+[ZnO]+[Al₂O₃])) is not particularly limited, but is preferably 4.0 or less, 3.0 or less, 2.0 or less, 1.8 or less, 1.5 or less, 1.2 or less, 1.0 or less, 0.90 or less, or 0.80 or less, and is particularly preferably 0.70 or less. Note that “([SiO₂]+[B₂O₃]+[P₂O₅])/((100×[SnO₂])×([Al₂O₃]+[Li₂O]+[Na₂O]+[K₂O]+[MgO]+[CaO]+[BaO]+[SrO]+[ZnO]))” is a value obtained by dividing the total content of SiO₂, B₂O₃, and P₂O₅ by a value obtained by multiplying 100 times the content of SnO₂ by the total of the contents of Al₂O₃, Li₂O, Na₂O, K₂O, MgO, CaO, BaO, SrO, and ZnO.

The molar ratio of [Li₂O]/([Na₂O]+[K₂O]) is preferably from 0.4 to 1.0, or from 0.5 to 0.9, and is particularly preferably from 0.6 to 0.8. When the molar ratio of [Li₂O]/([Na₂O]+[K₂O]) is too small, ion exchange performance may not be sufficiently exhibited. In particular, the efficiency of ion exchange between the Li ions contained in the glass and the Na ions in a molten salt is likely to decrease. Meanwhile, when the molar ratio [Li₂O]/([Na₂O]+[K₂O]) is too large, devitrified crystals are likely to precipitate in the glass, making it difficult to form the glass into a sheet shape using the overflow downdraw method or the like. Note that “[Li₂O]/([Na₂O]+[K₂O])” refers to a value obtained by dividing the content of Li₂O by the total content of Na₂O and K₂O.

Cl is a fining agent. In particular, when SnO₂ is used in combination with Cl, the size of bubbles in the glass is likely to increase, and the fining effect is easily exhibited. Meanwhile, when the content of Cl is too large, the Cl adversely affects the environment and equipment. Therefore, the lower limit range of Cl is preferably 0.001% or greater, 0.005% or greater, 0.008% or greater, 0.010% or greater, 0.015% or greater, 0.018% or greater, 0.019% or greater, 0.020% or greater, 0.021% or greater, 0.022% or greater, 0.023% or greater, 0.024% or greater, 0.025% or greater, 0.027% or greater, 0.030% or greater, 0.035% or greater, 0.040% or greater, 0.050% or greater, 0.070% or greater, or 0.090% or greater, and is particularly preferably 0.100% or greater, and the upper limit range is preferably 0.3% or less, 0.2% or less, 0.17% or less, or 0.15% or less, and is particular preferably 0.12% or less.

([SiO₂]+1.2×[P₂O₅]−3×[Al₂O₃]−[B₂O₃]−2×[Li₂O]−1.5×[Na₂O]−[K₂O]) is preferably −40% or greater, −30% or greater, −25% or greater, −24% or greater, −23% or greater, −22% or greater, −21% or greater, −20% or greater, or −19% or greater, and is particularly preferably −18% or greater. When ([SiO₂]+1.2×[P₂O₅]−3×[Al₂O₃]−[B₂O₃]−2×[Li₂O]−1.5×[Na₂O]−[K₂O]) is too small, the acid resistance is likely decrease. On the other hand, when ([SiO₂]+1.2×[P₂O₅]−3×[Al₂O₃]−[B₂O₃]−2×[Li₂O]−1.5×[Na₂O]−[K₂O]) is too large, ion exchange performance may not be sufficiently exhibited. Thus, ([SiO₂]+1.2×[P₂O₅]−3×[Al₂O₃]−[B₂O₃]−2×[Li₂O]−1.5×[Na₂O]−[K₂O]) is preferably 30% or less, 200 or less, 15% or less, 10% or less, or 5% or less, and is particularly preferably 0% or less. Note that ([SiO₂]+1.2×[P₂O₅]−3×[Al₂O₃]−[B₂O₃]−2×[Li₂O]−1.5×[Na₂O]−[K₂O]) is a value obtained by subtracting the total of three times the Al₂O₃, the content of B₂O₃, two times the content of Li₂O, 1.5 times the content of Na₂O, and the content of K₂O from the total of the content of SiO₂ and 1.5 times the content of P₂O₅,

In addition to the above components, a component, such as the following, may be added.

Compared with other components, CaO is a component that lowers viscosity in high temperature to improve meltability or formability and that raises strain point or the Vickers hardness without reducing devitrification resistance. However, when the content of CaO is too large, ion exchange performance may decrease, or an ion exchange solution may deteriorate during ion exchange treatments. Therefore, the upper limit range of CaO is preferably 6% or less, 5% or less, 4% or less, 3.5% or less, 3% or less, 2% or less, 1% or less, less than 1%, 0.7% or less, 0.5% or less, 0.3% or less, 0.1% or less, or 0.05% or less, and is particularly preferably 0.01% or less.

SrO and BaO are components that lower viscosity in high temperature to increase meltability or formability, and that raise the strain point or the Young's modulus. However, when the contents of SrO and BaO are too large, the ion exchange reaction is likely to be inhibited, and in addition, the density or thermal expansion coefficient may be unduly high, and the glass is likely to devitrify. Thus, suitable contents of SrO and BaO are each preferably from 0 to 2%, from 0 to 1.5%, from 0 to 1%, from 0 to 0.5%, or from 0 to 0.1%, and are particularly preferably from 0 to less than 0.1%.

ZrO₂ is a component that increases the Vickers hardness and also a component that increases viscosity or strain point near liquidus viscosity. However, when the content of ZrO₂ is too large, devitrification resistance may decrease significantly. Thus, the content of ZrO₂ is preferably from 0 to 3%, from 0 to 1.5%, or from 0 to 1%, and is particularly preferably from 0 to 0.1%.

TiO₂ is a component that improves ion exchange performance and lowers viscosity in high temperature. However, when the content of TiO₂ is too large, transparency or devitrification resistance is likely to decrease. As such, the content of TiO₂ is preferably from 0 to 3%, from 0 to 1.5%, from 0 to 1%, or from 0 to 0.1%, and is particularly preferably from 0.001 to 0.1 mol %.

As a fining agent, SO₃ and/or CeO₂ may be added at an amount from 0.001 to 1%.

Fe₂O₃ is an impurity that unavoidably gets mixed in from raw materials. The content of Fe₂O₃ is preferably less than 1000 ppm (less than 0.1%), less than 800 ppm, less than 600 ppm, or less than 400 ppm, and is particularly preferably less than 300 ppm. When the content of Fe₂O₃ is too large, the transmittance of the cover glass is likely to decrease.

Meanwhile, the lower limit range of the content of Fe₂O₃ is 10 ppm or greater, 20 ppm or greater, 30 ppm or greater, 50 ppm or greater, 80 ppm or greater, or 100 ppm or greater. When the content of Fe₂O₃ is too small, the cost of raw materials is likely to increase due to the use of high-purity raw materials, and as a result, product cannot be inexpensively manufactured.

Rare earth oxides such as Nd₂O₃, La₂O₃, Y₂O₃, Nb₂O₅, Ta₂O₅, and Hf₂O₃ are components that increase the Young's modulus. However, the raw material cost is high, and when the rare earth oxides are added in a large amount, devitrification resistance is likely to decrease. Thus, the content of rare earth oxides is preferably 5% or less, 4% or less, 3% or less, 2% or less, 1% or less, or 0.5% or less, and is particularly preferably 0.1 mol % or less.

From environmental considerations, the tempered glass sheet (glass sheet to be tempered) according to an embodiment of the present invention preferably has a glass composition that is substantially free of As₂O₃, Sb₂O₃, PbO, and F. Also from environmental considerations, the tempered glass sheet (glass sheet to be tempered) according to an embodiment of the present invention preferably has a glass composition that is substantially free of Bi₂O₃. The expression “substantially free of” means that although a specified component is not actively added as a glass component, addition of the specified component at an impurity level is permitted. Specifically, the expression refers to a case in which the content of the specified component is less than 0.05%.

The tempered glass sheet (glass sheet to be tempered) according to an embodiment of the present invention preferably has the following properties.

The density is preferably 2.55 g/cm³ or less, 2.53 g/cm³ or less, 2.50 g/cm³ or less, 2.49 g/cm³ or less, 2.48 g/cm³ or less, or 2.45 g/cm³ or less, and is particularly preferably from 2.35 to 2.44 g/cm³. The lower the density, the lighter the tempered glass sheet can be.

The thermal expansion coefficient at a temperature from 30 to 380° C. is preferably 150×10⁻⁷/° C. or lower, or 100×10⁻⁷/° C. or lower, and is particularly preferably from 50×10⁻⁷/° C. to 95×10⁻⁷/° C. Note that, “thermal expansion coefficient at a temperature from 30 to 380° C.” refers to a value obtained by measuring an average thermal expansion coefficient using a dilatometer.

The softening point is preferably 950° C. or lower, 940° C. or lower, 930° C. or lower, 920° C. or lower, 910° C. or lower, 900° C. or lower, 890° C. or lower, 880° C. or lower, 870° C. or lower, 860° C. or lower, 850° C. or lower, 840° C. or lower, 830° C. or lower, 820° C. or lower, or 810° C. or lower, and is particularly preferably from 800 to 700° C.

The temperature at a high-temperature viscosity of 10^{2.5} dPa·s is preferably 1680° C. or lower, 1670° C. or lower, 1660° C. or lower, 1650° C. or lower, 1640° C. or lower, 1630° C. or lower, 1620° C. or lower, 1600° C. or lower, 1550° C. or lower, 1520° C. or lower, or 1500° C. or lower, and is particularly preferably from 1300 to 1490° C. When the temperature at the high-temperature viscosity of 10^{2.5} dPa·s is too high, meltability and moldability decrease, making it difficult to mold the molten glass into a sheet shape.

The liquid phase viscosity is preferably 10^{3.74} dPa·s or greater, 10^{4.5} dPa·s or greater, 10^{4.8} dPa·s or greater, 10^{4.9} dPa·s or greater, 10^{5.0} dPa·s or greater, 10^{5.1} dPa·s or greater, 10^{5.2} dPa·s or greater, 10^{5.3} dPa·s or greater, of 10^{5.4} dPa·s or greater, and is particularly preferably 10^{5.5} dPa·s or greater. Note that, the higher the liquidus viscosity is, the more devitrification resistance is improved, and the less likely for devitrified stones to occur during forming. Here, “liquidus viscosity” refers to a value obtained by measuring the viscosity at the liquidus temperature using the platinum ball pull-up method. The term “liquidus temperature” refers to the following. Glass powder that passed through a standard 30-mesh sieve (500 μm) and remained on a 50-mesh sieve (300 μm) is placed in a platinum boat and kept in a gradient heating furnace for 24 hours. After that, the platinum boat is taken out, and the highest temperature at which devitrification (devitrified stones) inside the glass is observed via a microscope is defined as the “liquidus temperature”.

The tempered glass sheet (glass sheet to be tempered) according to an embodiment of the present invention preferably has a Young's modulus of 70 GPa or greater, 74 GPa or greater, or from 75 to 100, and particularly preferably from 76 to 90. When the Young's modulus is low, the cover glass tends to bend in a case in which the sheet thickness is small. Note that, “Young's modulus” can be calculated by a well-known resonance method.

The tempered glass sheet according to an embodiment of the present invention has a compressive stress layer on the surface. The compressive stress value at the outermost surface is preferably 165 MPa or greater, 200 MPa or greater, 220 MPa or greater, 250 MPa or greater, 280 MPa or greater, 300 MPa or greater, 310 MPa or greater, 320 MPa or greater, 330 MPa or greater, 340 MPa or greater, 350 MPa or greater, 360 MPa or greater, 370 MPa or greater, 380 MPa or greater, or 390 MPa or greater, and is particularly preferably 400 MPa or greater. The higher the compressive stress value on the outermost surface, the higher the Vickers hardness. On the other hand, if an extremely high compressive stress is formed on the surface, the tensile stress inherently present in the tempered glass sheet may increase significantly, and the dimensional change before and after the ion-exchange treatment may increase. As such, the compressive stress value on the outermost surface is preferably 1200 MPa or less, 1100 MPa or less, 1000 MPa or less, 900 MPa or less, 700 MPa or less, 680 MPa or less, or 650 MPa or less, and is particularly preferably 600 MPa or less. Note that the compressive stress value on the outermost surface tends to increase when the ion exchange time is decreased or when the temperature of the ion exchange solution is lowered.

The compressive stress value (CS₃₀) at a depth of 30 μm from the outermost surface is preferably 70 MPa or higher, 80 MPa or higher, 90 MPa or higher, 100 MPa or higher, 110 MPa or higher, 120 MPa or higher, 130 MPa or higher, 140 MPa or higher, 140 MPa or higher, or 150 MPa or higher, and is particularly preferably 160 MPa or higher. The larger the compressive stress value at the depth of 30 μm, the greater the strength. On the other hand, when an extremely high compressive stress is formed at a depth of 30 μm, the tensile stress inherently present in the tempered glass sheet may increase significantly, and the dimensional change before and after the ion-exchange treatment may increase. As such, the compressive stress value at the depth of 30 μm is preferably 400 MPa or less, 350 MPa or less, 300 MPa or less, 250 MPa or less, 230 MPa or less, 220 MPa or less, or 210 MPa or less, and is particularly preferably 200 MPa or less.

The Depth of Layer (DOC) is preferably 50 μm or greater, 60 μm or greater, 80 μm or greater, or 100 μm or greater, and is particularly preferably 120 μm or greater. The larger the Depth of Layer, the less likely it is for protrusions or sand grains on the pavement to reach the tensile stress layer when a smartphone is dropped, and thus the probability of cover glass damage can be reduced. Meanwhile, when the Depth of Layer is too large, dimensional change before and after ion exchange treatments may become large. Furthermore, the compressive stress value on the outermost surface tends to decrease. Thus, the Depth of Layer is preferably 200 μm or less, 180 μm or less, or 150 μm or less, and is particularly preferably 140 μm or less. Note that the Depth of Layer tends to increase when the ion exchange time is increased or when the temperature of the ion exchange solution is raised.

When the thickness of the tempered glass sheet is denoted by t, the depth of stress (DOC) is preferably 0.1·t or greater, or 0.15·t or greater, and is particularly preferably 0.2·t or greater. The upper limit is preferably 0.25·t or less.

The internal tensile stress value (CT) is preferably 100 MPa or less, and is particularly preferably 80 MPa or less. When the internal tensile stress value is too large, the tempered glass sheet may be prone to self-destruction due to a point impact or the like.

In the tempered glass sheet of the present invention, the sheet thickness is preferably 2.0 mm or less, 1.5 mm or less, 1.3 mm or less, 1.1 mm or less, 1.0 mm or less, or 0.9 mm or less, and is particularly preferably 0.8 mm or less. As the sheet thickness is reduced, the mass of the tempered glass sheet can be further reduced. Meanwhile, when the sheet thickness is too small, a desired mechanical strength becomes difficult to achieve. Therefore, the sheet thickness is preferably 0.1 mm or greater, 0.2 mm or greater, 0.3 mm or greater, 0.4 mm or greater, 0.5 mm or greater, or 0.6 mm or greater, and is particularly preferably 0.7 mm or greater.

The method for manufacturing the tempered glass sheet of the present invention is characterized by including: a preparation step of preparing a grass sheet for tempering including, as a glass composition in terms of mol %, from 45 to 70% of SiO₂, from 9 to 25% of Al₂O₃, from 0 to 10% of B₂O₃, from 4 to 15% of Li₂O, from 1 to 21% of Na₂O, from 0 to 10% of K₂O, from 0.03 to 10% of MgO, from 0 to 10% of ZnO, from 0 to 15% of P₂O₅, and from 0.001 to 0.30% of SnO₂, and the glass sheet for tempering satisfying [Li₂O]+[Na₂O]+[K₂O]≥15%, and ([Li₂O]+[Na₂O]+[K₂O]+[ZnO])/[Al₂O₃]≥1.1; and an ion exchange step of performing an ion exchange treatment for the glass sheet for tempering to obtain a tempered glass sheet having a compressive stress layer on a surface. Note that, the method for manufacturing a tempered glass sheet of the present invention includes not only a case in which the ion exchange treatment is performed a plurality of times, but also a case in which the ion exchange treatment is performed only once.

A method for manufacturing the glass to be tempered is, for example, as follows. Preferably, first, glass raw materials mixed to give a desired glass composition are put into a continuous melting furnace, and heated and melted at from 1400 to 1700° C.; after fining, the resulting molten glass is supplied to a forming device, formed into a sheet shape, and cooled. After the glass is formed into a sheet shape, a well-known method can be used to cut the glass into a predetermined size.

The overflow downdraw method is preferably used as the method of forming the molten glass into a sheet shape. In the overflow downdraw method, surfaces to become the surface of a glass sheet do not come into contact with the surface of the refractory forming body, and glass is formed into a sheet shape in a free-surface state. As such, an unpolished glass sheet with good surface quality can be manufactured at a low cost. Further, in the overflow downdraw method, an alumina-based refractory or a zirconia-based refractory is used as the refractory forming body. The tempered glass sheet (glass sheet to be tempered) according to an embodiment of the present invention has good compatibility with an alumina-based refractory and a zirconia-based refractory (particularly an alumina-based refractory), and thus the tempered glass sheet (glass sheet to be tempered) according to an embodiment of the present invention is less likely to react with these refractories to generate bubbles or stones.

Various forming methods can be used aside from the overflow downdraw method. For example, forming methods such as a float method, a downdraw method (slot downdraw method, redraw method, etc.), a roll-out method, or a press method can be used.

When subjecting the molten glass to forming, the molten glass is preferably cooled at a cooling rate of 3° C./min or greater and less than 1000° C./min in the temperature range between the annealing point and the strain point of the molten glass. The lower limit of the cooling rate is preferably 10° C./min or greater, 20° C./min or greater, or 30° C./min or greater, and particularly preferably 50° C./min or greater. The upper limit of the cooling rate is preferably less than 1000° C./min, or less than 500° C./min, and particularly preferably less than 300° C./min. When the cooling rate is too fast, the structure of the glass becomes rough, making it difficult to increase the Vickers hardness after ion exchange treatments. Meanwhile, when the cooling rate is too slow, production efficiency of the glass sheet decreases.

In the method for manufacturing a tempered glass sheet, a plurality of ion exchange treatments can be performed. Preferably, the plurality of ion exchange treatments include first performing an ion exchange treatment by immersing the glass sheet to be tempered in a molten salt including KNO₃ molten salt and/or NaNO₃ molten salt, and then performing an ion exchange treatment by immersing the glass sheet in a molten salt including the NaNO₃ molten salt. By doing so, the compressive stress value on the outermost surface can be increased while ensuring a large Depth of Layer.

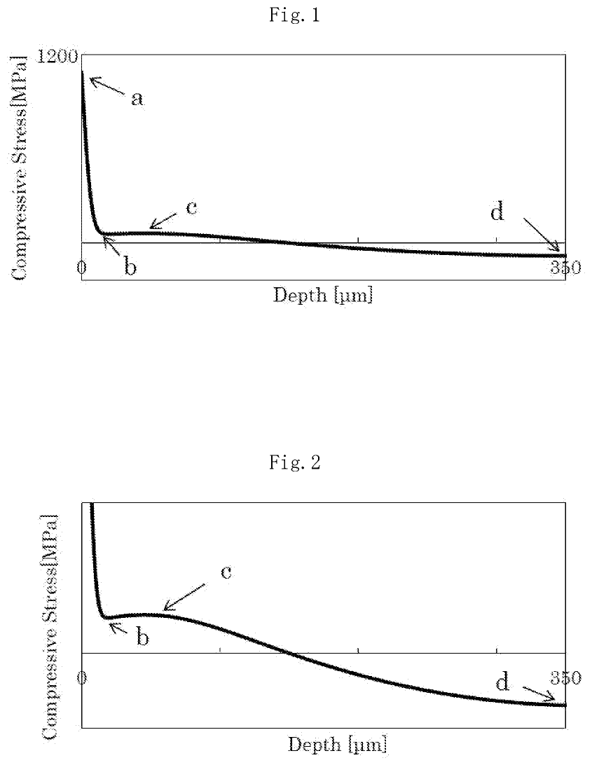

In particular, in the method for manufacturing a tempered glass sheet of the present invention, it is preferable to first implement an ion exchange treatment (first ion exchange step) in which the glass sheet to be tempered is immersed in NaNO₃ molten salt or a mixed molten salt of NaNO₃ and KNO₃, and then implement an ion exchange treatment (second ion exchange step) in which the glass sheet to be tempered is immersed in a mixed molten salt of KNO₃ and LiNO₃. When performed in this manner, the above-described non-monotonic stress profile illustrated in FIG. 1, that is, a stress profile having at least a first peak, a first bottom, a second peak, and a second bottom can be formed. As a result, the probability of cover glass damage can be significantly reduced when a smartphone is dropped.

In the first ion exchange step, the Li ions contained in the glass are exchanged with the Na ions in the molten salt, and in a case in which a mixed molten salt of NaNO₃ and KNO₃ is used, the Na ions contained in the glass are further exchanged with the K ions in the molten salt. Here, the ion exchange between the Li ions contained in the glass and the Na ions in the molten salt is faster and more efficient than the ion exchange between the Na ions contained in the glass and the K ions in the molten salt. In the second ion exchange step, the Na ions in the vicinity of the glass surface (a shallow region from the outermost surface to 20% of the sheet thickness) are exchanged with the Li ions in the molten salt, and in addition, the Na ions in the vicinity of the glass surface (a shallow region from the outermost surface to 20% of the sheet thickness) are exchanged with the K ions in the molten salt. That is, in the second ion exchange step, the K ions having a large ion radius can be introduced while the Na ions in the vicinity of the glass surface are removed. As a result, it is possible to increase the compressive stress value on the outermost surface while maintaining a large Depth of Layer.

In the first ion exchange step, the temperature of the molten salt is preferably from 360 to 400° C., and the ion exchange time is preferably from 30 minutes to 6 hours. In the second ion exchange step, the temperature of the ion exchange solution is preferably from 370 to 400° C., and the ion exchange time is preferably from 15 minutes to 3 hours.

In order to form a non-monotonic stress profile, the mixed molten salt of NaNO₃ and KNO₃ used in the first ion exchange step preferably has a concentration of NaNO₃ higher than that of KNO₃, and the mixed molten salt of KNO₃ and LiNO₃ used in the second ion exchange step preferably has a concentration of KNO₃ higher than that of LiNO₃.

In the mixed molten salt of NaNO₃ and KNO₃ used in the first ion exchange step, the concentration of KNO₃ is preferably 0 mass % or greater, 0.5 mass % or greater, 1 mass % or greater, 5 mass % or greater, 7 mass % or greater, 10 mass % or greater, or 15 mass % of greater, and is particularly preferably from 20 to 90 mass %. When the concentration of KNO₃ is too high, the compressive stress value formed when the Li ions contained in the glass exchanges with the Na ions in the molten salt may be too small. Meanwhile, when the concentration of KNO₃ is too low, measuring stress using the FSM-6000 surface stress meter may become difficult.

In the mixed molten salt of KNO₃ and LiNO₃ used in the second ion exchange step, the concentration of LiNO₃ is preferably from greater than 0 mass % to 5 mass %, from greater than 0 mass % to 3 mass %, or from greater than 0 mass % to 2 mass %, and is particularly preferably from 0.1 to 1 mass %. When the concentration of LiNO₃ is too low, the Na ions in the vicinity of the glass surface are less likely to be removed. Meanwhile, when the concentration of LiNO₃ is too high, the compressive stress value resulting from the ion exchange between the Na ions in the vicinity of the glass surface and the K ions in the molten salt may decrease too much.

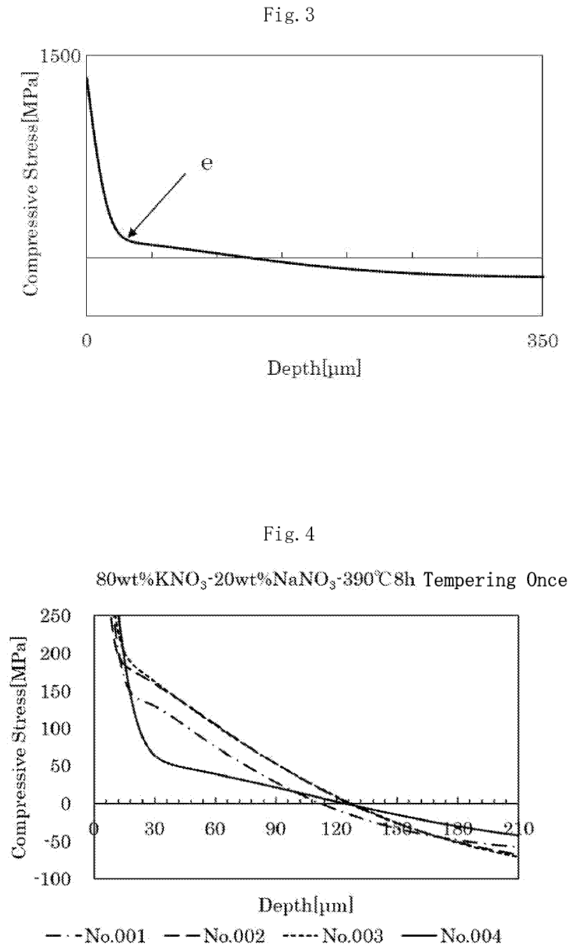

In the method for manufacturing a tempered glass sheet according to the present invention, an ion exchange treatment that involves immersion in a mixed molten salt of NaNO₃ and KNO₃ can also be used. When this ion exchange treatment is performed once, a stress profile having an inflection point (e in FIG. 3) can be efficiently formed. When a stress profile having an inflection point is formed, a glass having high surface compressive stress and a deep Depth of Layer can be easily obtained. Note that, for example, when the stress profile can be approximated by a polyline composed of two straight lines, the inflection point can be determined as a point on the stress profile at a depth of an intersection point of the two straight lines (point at which the polyline bends). For the approximation of a straight line, a known method such as the least squares method can be used, for example.

The depth of the inflection point is preferably a position that is shallower than 20 μm from the surface (closer to the surface), and is more preferably a position that is shallower than 18 μm from the surface. The compressive strain at the inflection point is preferably 80 MPa or greater, and is particularly preferably 100 MPa or greater.

### Example 1

The present invention will be described below based on examples. The following examples are merely exemplary. The present invention is not limited to the following examples in any way.

Table 1 describes glass compositions and glass properties of Examples (Sample Nos. 001 to 003 and 005 to 008) of the present invention and a Comparative Example (Sample No. 004). In the table, “N.A.” means not measured, (Li+Na+K+Zn)/Al means a molar ratio of ([Li₂O]+[Na₂O]+[K₂O]+[ZnO])/[Al₂O₃], and Li+Na+K means a total amount of ([Li₂O]+[Na₂O]+[K₂O]).

TABLE 1

| | No. 001 | No. 002 | No. 003 | No. 004 | No. 005 | No. 006 | No. 007 | No. 008 |
|---|---|---|---|---|---|---|---|---|
| Component | mol % | mol % | mol % | mol % | mol % | mol % | mol % | mol % |
| SiO₂ | 59.94 | 59.39 | 59.39 | 60.29 | 63.03 | 63.03 | 63.03 | 68.15 |
| Al₂O₃ | 15.81 | 15.81 | 16.88 | 18.80 | 13.81 | 15.81 | 13.81 | 9.44 |
| B₂O₃ | 0.00 | 0.00 | 0.00 | 0.10 | 0.00 | 0.00 | 0.00 | 0.00 |
| Li₂O | 7.34 | 8.41 | 7.34 | 7.20 | 6.34 | 4.34 | 4.34 | 8.05 |
| Na₂O | 12.10 | 12.10 | 12.10 | 8.10 | 11.10 | 11.10 | 11.10 | 8.28 |
| K₂O | 1.50 | 0.00 | 0.00 | 0.45 | 0.00 | 0.00 | 0.00 | 2.02 |
| MgO | 2.00 | 2.00 | 2.00 | 0.50 | 0.03 | 0.03 | 0.03 | 0.03 |
| ZnO | 1.16 | 2.14 | 2.14 | 0.00 | 3.16 | 3.16 | 5.16 | 3.97 |
| SnO₂ | 0.04 | 0.04 | 0.04 | 0.16 | 0.04 | 0.04 | 0.04 | 0.04 |
| Fe₂O₃ | 0.002 | 0.002 | 0.002 | 0.002 | 0.002 | 0.002 | 0.002 | 0.002 |
| TiO₂ | 0.002 | 0.001 | 0.001 | 0.001 | 0.002 | 0.002 | 0.001 | 0.002 |
| P₂O₅ | 0.00 | 0.00 | 0.00 | 4.30 | 2.47 | 2.47 | 2.47 | 0.00 |
| Cl | 0.10 | 0.10 | 0.10 | 0.10 | 0.02 | 0.02 | 0.02 | 0.02 |
| Li + Na + K | 20.94 | 20.51 | 19.44 | 15.75 | 17.44 | 15.44 | 15.44 | 18.35 |
| (Li + Na + K + Zn)/Al | 1.40 | 1.43 | 1.28 | 0.84 | 1.49 | 1.18 | 1.49 | 2.36 |
| ρ(g/cm³) | 2.483 | 2.497 | 2.497 | 2.407 | 2.466 | 2.466 | 2.497 | 2.486 |
| a_{30-380° C.}(×10⁻⁷/° C.) | 97.4 | 92.1 | 89.6 | 74.8 | 83.6 | 77.2 | 76.3 | 89.4 |
| Ts (° C.) | 768 | 771 | 809 | 926 | 838 | 894 | 850 | 744 |
| 10^{2.5} dPa · s (° C.) | 1461 | 1424 | 1462 | 1579 | 1538 | 1597 | 1558 | 1441 |
| E (GPa) | 80 | 82 | 82 | 76 | 76 | 75 | 75 | 78 |
| CS_{Na} (MPa) | 333 | 397 | 367 | 260 | N.A. | N.A. | N.A. | N.A. |
| DOL_ZERO_{Na} (μm) | 75.4 | 89.2 | 100.5 | 125.8 | N.A. | N.A. | N.A. | N.A. |

Each sample in the tables was produced as follows. First, glass raw materials were mixed to give a glass composition presented in the table, and the mixture was melted at 1600° C. for 21 hours using a platinum pot. Then, the resulting molten glasses were poured onto a carbon plate and formed into a flat plate shape, and then cooled at 3° C./min in a temperature range from the annealing point to the strain point, resulting in glass sheets (glass sheets to be tempered). The surface of the obtained glass sheet was optically polished so as to obtain a sheet thickness of 1.5 mm, and then various properties were evaluated.

The density (ρ) is a value measured using the well-known Archimedes method.

The thermal expansion coefficient at from 30 to 380° C. (α_{30-380° C.}) is a value obtained by measuring an average thermal expansion coefficient using a dilatometer.

The temperature (10^{2.5} dPa·s) at the high-temperature viscosity of 10^{2.5} dPa·s is a value measured by the platinum sphere pull up method.

The softening point (Ts) is a value measured based on the method of ASTM C338.

Young's modulus (E) was calculated by the method in accordance with JIS R 1602-1995 “Elastic Modulus Test Method for Fine Ceramics”.

Subsequently, each of the glass sheets was immersed in a NaNO₃ molten salt having a temperature of 380° C. for 1 hour to undergo an ion exchange treatment, resulting in a tempered glass sheet. After the glass surface was washed, the compressive stress value (CS_{Na}) and the Depth of Layer (DOL_ZERO_{Na}) on the outermost surface were calculated from a retardation distribution curve observed using a scattered light photoelastic stress meter SLP-1000 (available from Orihara Industrial Co., Ltd.). Here, DOL_ZERO_{Na} is the depth at which the stress value becomes zero. Note that the stress characteristics were calculated using a refractive index of 1.51 and an optical elasticity constant of 29.0 [(nm/cm)/MPa] for each sample.

As is clear from Table 1, the content of [Li₂O]+[Na₂O]+[K₂O] and the molar ratio of ([ZnO]+[Li₂O]+[Na₂O]+[K₂O])/[Al₂O₃] of Sample Nos. 001 to 003 and Sample Nos. 005 to 008 were appropriate, and thus the softening points of these samples were low, and the compressive stress values (CS_{Na}) of the compressive stress layers at the outermost surface when subjected to an ion exchange treatment with the NaNO₃ molten salt were large. Thus, the Sample Nos. 001 to 003 and Nos. 005 to 008 are easy to bend and mold, and the compressive stress can be increased. On the other hand, the molar ratio of ([ZnO]+[Li₂O]+[Na₂O]+[K₂O])/[Al₂O₃] of Sample No. 004 was overly low, and thus the softening point was high, and the compressive stress value (CS_{Na}) of the compressive stress layer at the outermost surface when subjected to the ion exchange treatment with NaNO₃ molten salt was small.

### Example 2

First, glass raw materials were mixed to obtain the glass compositions described in Table 1 for Sample Nos. 001 to 004, and each mixture was melted at 1600° C. for 21 hours using a platinum pot. Then, the resulting molten glasses were poured onto a carbon plate and formed into a flat plate shape, and then cooled at 3° C./min in a temperature range from the annealing point to the strain point, resulting in glass sheets (glass sheets to be tempered). The surface of each of the obtained glass sheets was optically polished to obtain a glass sheet with a sheet thickness of 0.7 mm.

Each obtained glass sheet to be tempered was subjected to an ion exchange treatment by immersing the glass sheet in a mixed molten salt of KNO₃ and NaNO₃ (80 mass % KNO₃, 20 mass % NaNO₃) at 390° C. for 8 hours. Further, the surfaces of the resulting tempered glass sheets were washed, and then the stress profiles of the tempered glass sheets were measured using a scattered light photoelastic stress meter SLP-1000 (available from Orihara Industrial Co., Ltd.) and a surface stress meter FSM-6000 (available from Orihara industrial Co., Ltd.). The results indicated that a stress profile having an inflection point as illustrated in FIG. 3 was obtained with each tempered glass sheet.

Table 2 presents the compressive stress value (CS) at the outermost surface, the Depth of Layer (DOC), the compressive stress value (CS₃₀) at a depth of 30 μm, and the internal tensile stress value (CT) of the stress profile of each sample. Moreover, FIG. 4 illustrates the stress profiles of each sample having an inflection point.

TABLE 2

| Stress Profile | No. 001 | No. 002 | No. 003 | No. 004 |
|---|---|---|---|---|
| CS (MPa) | 665 | 789 | 802 | 625 |
| DOC (μm) | 112 | 127 | 127 | 125 |
| CS₃₀ (MPa) | 130 | 159 | 162 | 64 |
| CT (MPa) | 64.8 | 88.2 | 96.9 | — |

As is clear from Table 2 and FIG. 4, the CS₃₀ in the stress profile of each of Sample Nos. 001 to 004 was 120 MPa, and it is considered that the strength is improved. On the other hand, the CS₃₀ in the stress profile of Sample No. 004 was less than 100 MPa, which is a low value.

### INDUSTRIAL APPLICABILITY

The tempered glass sheet according to an embodiment of the present invention is suitable as a cover glass for a touch panel display, such as that of a mobile phone, a digital camera, or a personal digital assistant (PDA). In addition to those applications, the tempered glass sheet according to an embodiment of the present invention is expected to be applied to an application requiring high mechanical strength, such as window glass, a substrate for a magnetic disk, a substrate for a flat panel display, a substrate for a flexible display, cover glass for a solar cell, cover glass for a solid-state image sensor, and in-vehicle cover glass.

1. A tempered glass sheet comprising, as a glass composition in terms of mol %, in a tempered glass sheet having a compressive stress layer on a surface, from 45 to 70% of SiO₂, from 9 to 25% of Al₂O₃, from 0 to 10% of B₂O₃, from 4 to 15% of Li₂O, from 1 to 21% of Na₂O, from 0 to 10% of K₂O, from 0.03 to 10% of MgO, from 0 to 10% of ZnO, from 0 to 15% of P₂O₅, and from 0.001 to 0.30% of SnO₂, the tempered glass sheet satisfying [Li₂O]+[Na₂O]+[K₂O]≥15%, and ([Li₂O]+[Na₂O]+[K₂O]+[ZnO])/[Al₂O₃]≥1.1.

2. The tempered glass sheet according to claim 1, wherein a content of ZnO is 1.5 mol % or greater.

3. The tempered glass sheet according to claim 1, wherein a content of Cl is 0.02 mol % or greater.

4. The tempered glass sheet according to claim 1, wherein a softening point is 900° C. or lower.

5. The tempered glass sheet according to claim 1, wherein a compressive stress value of an outermost surface of the compressive stress layer is from 200 to 1200 MPa, and a compressive stress value at a depth of 30 μm is from 70 to 400 MPa.

6. The tempered glass sheet according to claim 1, wherein a Depth of Layer of the compressive stress layer is from 50 to 200 μm.

7. The tempered glass sheet according to claim 1, wherein a temperature at a high-temperature viscosity of 10^{2.5} dPa·s is 1600° C. or lower.

8. The tempered glass sheet according to claim 1, comprising an overflow-confluent surface at a central portion in a sheet thickness direction.

9. The tempered glass sheet according to claim 1, which is for use as a cover glass for a touch panel display.

10. The tempered glass sheet according to claim 1, wherein a content of Fe₂O₃ is from 0.001 to 0.1 mol %.

11. The tempered glass sheet according to claim 1, wherein a content of TiO₂ is from 0.001 to 0.1 mol %.

12. The tempered glass sheet according to claim 1, wherein a stress profile in a thickness direction includes at least a first peak, a second peak, a first bottom, and a second bottom.

13. The tempered glass sheet according to claim 1, wherein a stress profile in a thickness direction includes an inflection point.

14. A method for manufacturing a tempered glass sheet, the method comprising: a preparation step of preparing a glass sheet for tempering comprising, as a glass composition in terms of mol %, from 45 to 70% of SiO₂, from 9 to 25% of Al₂O₃, from 0 to 10% of B₂O₃, from 4 to 15% of Li₂O, from 1 to 21% of Na₂O, from 0 to 10% of K₂O, from 0.03 to 10% of MgO, from 0 to 10% of ZnO, from 0 to 15% of P₂O₅, and from 0.001 to 0.30% of SnO₂, the glass sheet for tempering satisfying [Li₂O]+[Na₂O]+[K₂O]≥15%, and ([Li₂O]+[Na₂O]+[K₂O]+[ZnO]/[Al₂O₃]≥1.1; and an ion exchange step of performing an ion exchange treatment for the glass sheet for tempering to obtain a tempered glass sheet comprising a compressive stress layer on a surface.

15. The method for manufacturing a tempered glass sheet according to claim 14, wherein a mixed molten salt of KNO₃ and NaNO₃ is used for the ion exchange treatment.

16. The method for manufacturing a tempered glass sheet according to claim 14, wherein the ion exchange treatment is performed once.

17. A glass sheet for tempering comprising, as a glass composition in terms of mol %, in an ion-exchangeable glass sheet for tempering, from 45 to 70% of SiO₂, from 9 to 25% of Al₂O₃, from 0 to 10% of B₂O₃, from 4 to 15% of Li₂O, from 1 to 21% of Na₂O, from 0 to 10% of K₂O, from 0.03 to 10% of MgO, from 0 to 10% of ZnO, from 0 to 15% of P₂O₅, and from 0.001 to 0.30% of SnO₂, the glass sheet for tempering satisfying [Li₂O]+[Na₂O]+[K₂O]≥15%, and ([Li₂O]+[Na₂O]+[K₂O]+[ZnO]/[Al₂O₃]≥1.1.
